(19) United States
(12) Patent Application Publication
(10) Pub. No.: US 2024/0399561 A1
(43) Pub. Date: Dec. 5, 2024

(54) TOOL CHEST WITH SLIDABLE AND PIVOTABLE LIDS

(71) Applicant: Mechanic's Time Savers, Inc., Dallas, TX (US)

(72) Inventors: Shawn Winnard, Dallas, TX (US); Richard Heidelberger, Dallas, TX (US)

(21) Appl. No.: 18/697,512

(22) PCT Filed: Oct. 3, 2022
(86) PCT No.: PCT/US2022/077491

§ 371 Date: Apr. 1, 2024

Related U.S. Application Data
(60) Provisional application No. 63/251,393, filed on Oct. 1, 2021.

(51) Int. Cl. B25H 3/02; B62B 3/00; B62B 5/04

(52) U.S. Cl. CPC B25H 3/028; B62B 3/004; B62B 3/005; B62B 5/0433

(57) ABSTRACT

A tool box or container has two lids, one sliding and one pivoting, both providing access to an interior space.

### CROSS-REFERENCE TO RELATED APPLICATIONS

This is a U.S. National Stage Application based on and claiming priority to the PCT Application PCT/US22/77491, filed Oct. 3, 2022, and claims the benefit of U.S. Provisional Application No. 63/251,393, filed Oct. 1, 2021.

### TECHNICAL FIELD

The disclosure relates to tool boxes, and more specifically to tool boxes providing access to an interior space by a movable lid positioned above the space.

### BRIEF DESCRIPTION OF THE DRAWINGS

For a more complete understanding of the present disclosure, and the advantages thereof, reference is now made to the following description which is to be taken in conjunction with the accompanying drawings in which like reference numerals indicate like parts and wherein:

FIG. 1 is an orthogonal view of an exemplary tool chest according to aspects of the disclosure.

FIG. 2 is an orthogonal view of the exemplary tool chest of FIG. 1, with a pivotable lid in the open position.

FIG. 3 is a side view of the exemplary tool chest of FIG. 1 with the pivotable lid in the open position.

FIG. 4 is a side view of the exemplary tool chest of FIG. 1 with a slidable lid in an open position.

FIGS. 5A-B are, respectively, top and bottom orthogonal views of the lid assembly of the exemplary tool chest with the slidable lid in an open position.

FIGS. 6A-B are detail views of the slidable lid latch assembly in a latched and unlatched position, respectively.

FIG. 7 is a side view of an exemplary embodiment according to aspects of the disclosure having a lid assembly with a pivotable lid mounted to the slidable lid assembly, with both pivotable and slidable lids in a closed position.

FIG. 8 is a side view of the exemplary embodiment of the disclosure of FIG. 7, wherein the slidable lid is in an open position and the pivotable lid is in a closed position.

FIG. 9 is a side view of the exemplary embodiment of the disclosure of FIG. 7, wherein the pivotable lid is in an open position and the slidable lid is in a closed position.

FIG. 10 is a detail partial rear view of a latch assembly mounted to the frame of the pivotable lid assembly, according to aspects of the disclosure.

FIG. 11 is a detail partial rear view of an exemplary locking assembly 120 according to aspects of the disclosure.

### DETAILED DESCRIPTION OF THE DISCLOSURE

Tool chests provide storage space for various tools, tool accessories, fasteners, and the like. Typically, access to the storage space is by drawer or hinged door. Access is sometimes provided by sliding, segmented panels and the like.

The upper surface of the tool chest often provides a work surface for the user. The user can place tools, equipment, and project items being used for a particular job on top of the tool chest. That is, tools are removed from storage in the tool chest and placed on top of the tool chest's upper surface, often along with items being worked on. The tool chest thus acts as a type of work table or bench.

Generally, there are three types of tool chest top. A stationary top provides an upper surface which does not move and acts as a stationary work surface. However, a stationary top does not provide for accessing the interior of the tool chest, which must then be provided by doors, drawers or the like.

A sliding or slidable lid slides to provide access to a storage space below the lid. The upper surface of a slidable lid remains horizontal during movement, such that tools and items positioned on top of the upper surface do not fall from the surface even while the interior of the tool chest is accessed. However, a slidable lid often does not provide easy access or complete access to the full interior space below the tool chest lid. A sliding lid moves between a closed position, in which the lid is positioned over the storage space and encloses the space. The sliding lid moves to an open position by sliding movement relative to the lower assembly of the tool chest. In the open position, the sliding lid is cantilevered out from the tool chest lower assembly. Consequently, a sliding lid is often limited in its movement, such as by a stop, shoulder, or other mechanisms, to prevent overbalancing of the tool chest. Thus, the slidable lid does not slide to uncover all of the interior storage space. For example, a slidable lid may not provide access to items at the rear of the interior storage space, making it difficult to reach items at the rear of the space. Items at the rear of the space may be difficult to access and remove from the space due to limitation of available space by other tools and items in the space and the position of the open slidable lid above the space.

A hinged or pivotable tool chest lid pivots from a horizontal orientation, wherein the upper surface is horizontal and usable for holding items, to an open position, wherein the top and upper surface are no longer horizontal and no longer suitable for supporting tools and items. A typical pivoting lid may pivot to an open position between 45 and 120 degrees from the horizontal. Some pivotable lids may open to 180 degrees from the original closed position. A pivoting lid provides easy and complete access to the interior space of the tool chest. However, tools and items must be removed from the upper surface when opening the top to prevent them falling from the tool chest.

Tool chests can be relatively small and hand-carried, or can be much larger for use in a garage, warehouse or the like. A hand-held tool chest, for example, will lack much or all of the lower assembly of the exemplary tool chest described with respect to the Figures, for example lacking vertical legs, wheels, etc. Larger tool chests can be tool carts, such as seen in the exemplary tool chest, having wheels for movement. It is understood that the claims alone define the invention and that the exemplary embodiments described herein are without limitation. The lid assembly having both pivoting and sliding lids can be employed on hand-carried, stand-alone, and rolling cart tool chests.

### Detailed Description of Certain Embodiments

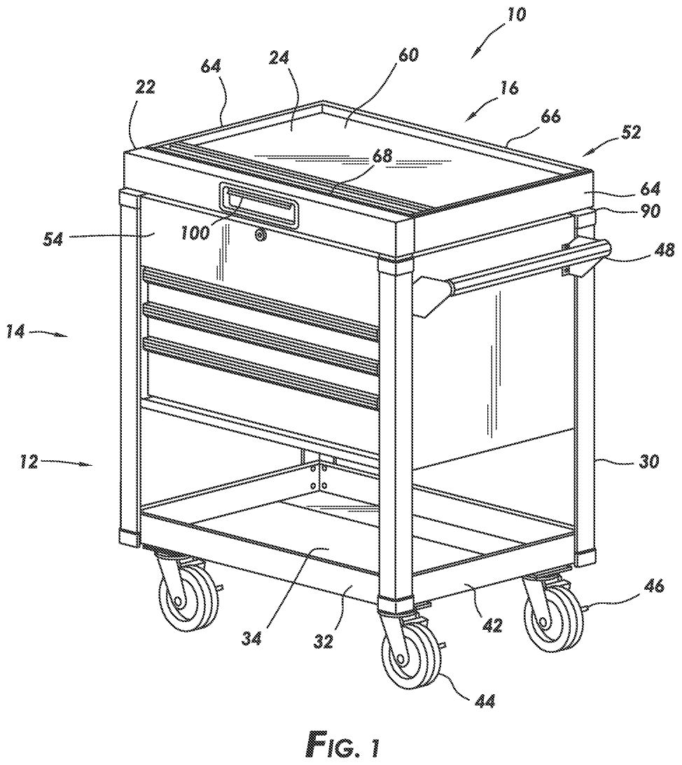

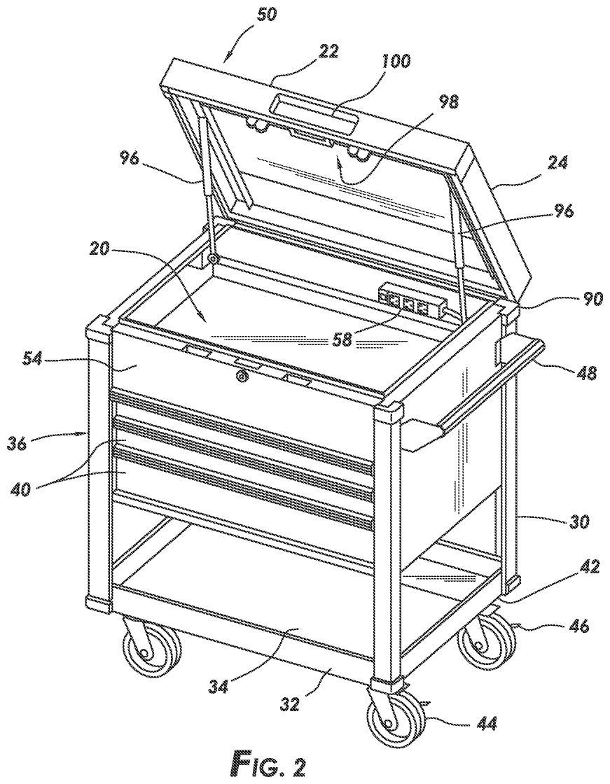

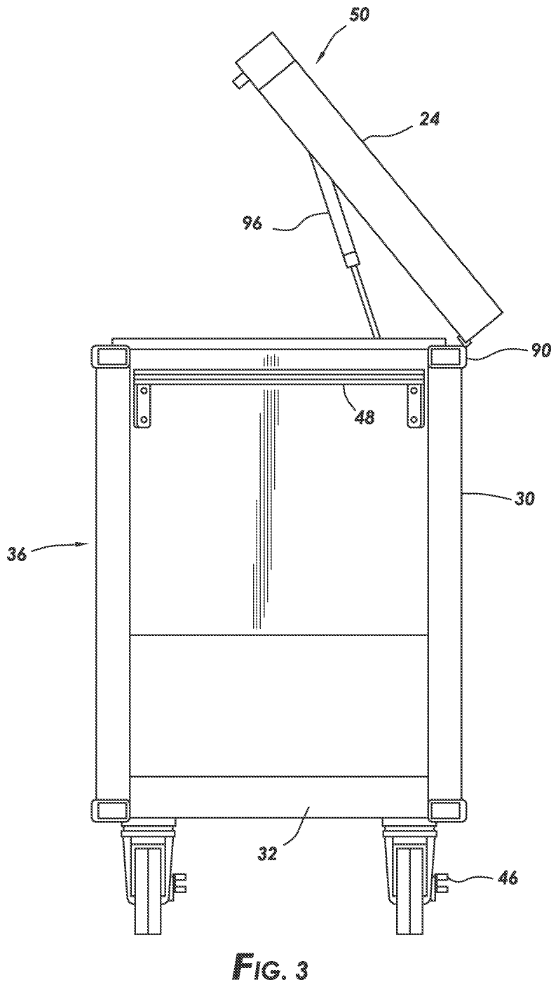

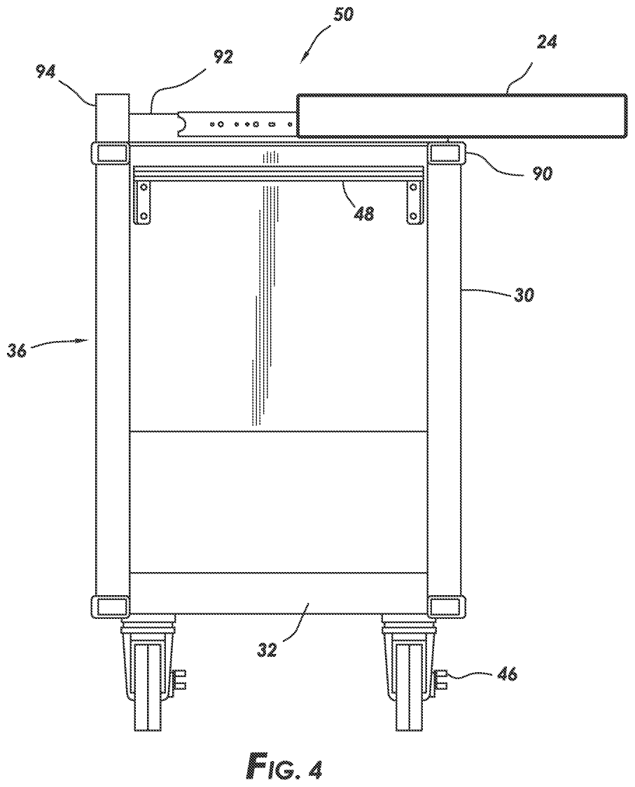

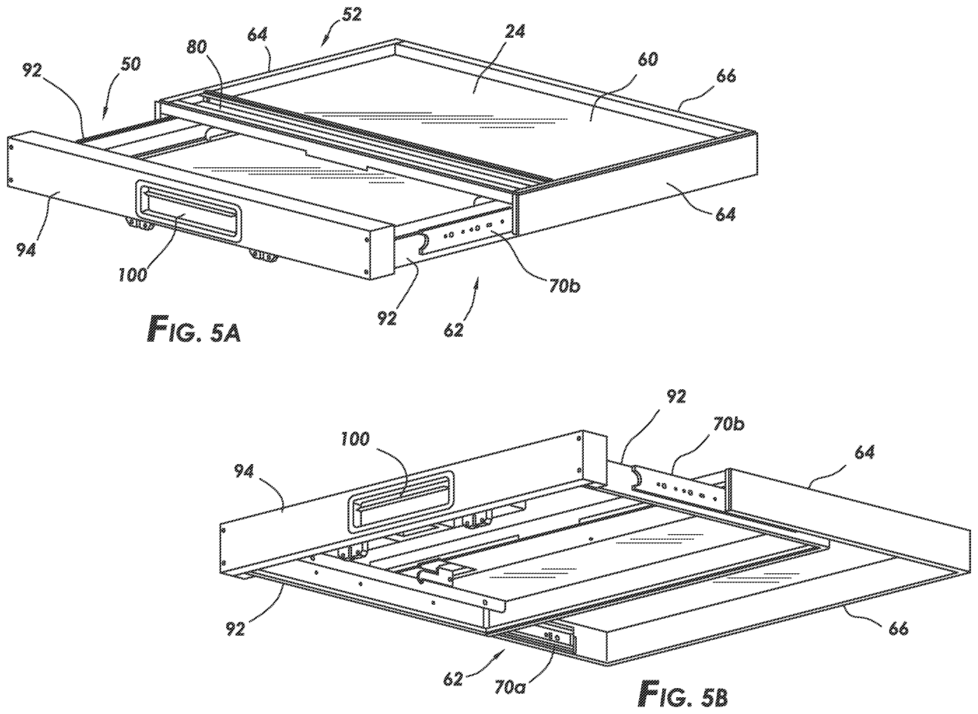

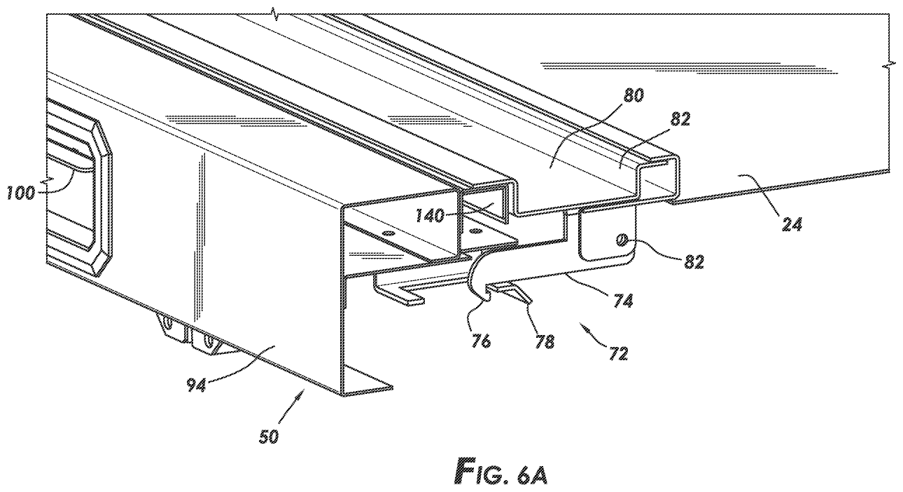

An exemplary tool chest 10 is seen in the accompanying Figures. FIG. 1 is an orthogonal view of an exemplary tool chest according to aspects of the disclosure. FIG. 2 is an orthogonal view of the exemplary tool chest of FIG. 1, with a pivotable lid in the open position. FIG. 3 is a side view of the exemplary tool chest of FIG. 1 with the pivotable lid in the open position. FIG. 4 is a side view of the exemplary tool chest of FIG. 1 with a slidable lid in an open position. FIGS. 5A-B are, respectively, top and bottom orthogonal views of the lid assembly of the exemplary tool chest with the slidable lid in an open position. FIGS. 6A-B are detail views of the slidable lid latch assembly in a latched and unlatched position, respectively. The exemplary tool chest is discussed with reference to the Figures without limitation.

The exemplary tool chest 10 generally has a lower assembly 12 and an upper assembly 14, the upper assembly 14 having a lid assembly 16 which can be opened to provide access to the chest interior space 20 in two ways: by sliding movement of a slidable lid and by pivoting movement of a pivotable lid. In FIG. 1, the lid assembly 16 is seen with both the pivotable lid 22 in a closed position and the slidable lid 24 in a closed position, with the interior space 20 enclosed to maintain tools and the like, with access to the interior space prohibited. In FIG. 2, the pivotable lid 22 is in an open position, providing access to the interior space 20, while the slidable lid 24 remains closed. In FIG. 4, the slidable lid 24 is in an open position, allowing access to the interior space 20, while the pivotable lid 22 remains in a closed position.

### Lower Assembly

The lower assembly 12 of the exemplary tool chest 10 has a frame composed of generally vertical members 30 and generally horizontal members 32. The vertical and horizontal members can comprise L-shaped, U-shaped, or other shaped longitudinal channels or tubulars. For example, the vertical posts seen in the Figures are generally L-shaped posts. Alternately, the vertical and horizontal members can comprise larger members, such as panels, walls, sheets, and the like. For example, a generally horizontal member is seen as a generally planar shelf 34, supported by the vertical or horizontal members attached thereto.

The lower assembly 12 of the tool chest 10 can be made up of various storage compartments 36 of desired size and shape. The storage compartments 36 can be shelf units, like shelf 34 (without doors), cabinet units with doors (not shown), drawer units 40, and the like. The shelf 34 is seen having a surface for holding items above the floor surface and with upwardly extending flanges 42 along the shelf perimeter to prevent items from sliding off the shelf.

Cabinet units can include an enclosed space having a shelves and one or more doors. The doors can open pivotably, such as on hinges, slidingly, such as upon rails or channels. The doors can open by horizontal movement, vertical movement, roll-top movement, etc. The doors can be segmented, foldable, or rigid. Multiple doors can span the width of the tool chest. Multiple doors can cooperate, such as multi-slide doors which “stack” one in front of the other when the doors are in the open position. The interior of a cabinet unit can be divided into storage spaces, as desired. For example, a cabinet unit can have an interior space which is divided by multiple shelves and/or side walls into multiple storage areas.

Drawer units 40 may comprise at least one drawer which can be opened and closed by horizontal movement. The drawer is typically mounted on rails, slides, or similar supporting members to allow sliding opening and closing of the drawer. Multiple drawers can be employed, stacked atop one another or side-by-side. A drawer member can define an interior space which can be divided into storage areas, such as by drawer dividers and the like.

The lower assembly 12 can include wheels 44 or the like for allowing movement of the entire tool chest 10 across the floor. The wheels 44 can have locks 46 to selectively allow and prevent rotation of the wheels 44. The lower or upper assembly can include handles 48 or rails for pushing and pulling the tool chest across the floor.

While the exemplary tool chest 10 includes a lower assembly, wheels and the like, it is understood that the tool chest may also comprise a hand-carried tool chest lacking the height, wheels, lengthy vertical supports and the like.

### Upper Assembly

An upper assembly 14 generally comprises a lid assembly 16 having a pivoting or pivotable lid assembly 50 and a sliding or slidable lid assembly 52, and a compartment 54 defining an interior space 20. The compartment 54 is generally below the sliding and pivoting door assemblies, when they are in their closed positions, such that the interior space 20 is enclosed and tools are maintained in the interior space. The interior space 20 is accessed generally from above when either of the lid assemblies is moved to an open position.

Typically the compartment 54 will define a rectangular, columnar interior space 20 made-up of opposing side walls, opposing front and rear walls, and a bottom wall for supporting tools, fasteners, work pieces, and the like. The compartment can include various frame members to support, strengthen, or provide mounting locations for the wall members. The interior space can be accessed when the sliding lid assembly is in an open position, even while the pivoting lid assembly remains in a closed position. Similarly, the interior space can be accessed when the pivoting lid assembly is in an open position, even when the sliding lid remains in the closed position. The interior space 20 can also house electrical outlets 58 and the like for providing power to power tools, mobile phones and the like. The electrical outlets are electrically connected to appropriate cords and a plugs to provide the outlets with a power source. Alternately, the outlets can be powered by a rechargeable battery, as is known in the art.

### Lower Assembly

The disclosure provides for an upper work surface 60 that can be selectively moved either slidingly or pivotally to provide access to the interior storage space of the compartment. The upper work surface 60 is generally horizontal while the slidable lid assembly is in the open and closed positions. Often, a workman will place a project, tools, and the like on the upper work surface. Use of the slidable lid assembly allows the project and materials to remain on the slidable lid while still allowing access to the interior space. The work surface 58 moves from the horizontal position when the pivotable lid assembly is in the open position, generally requiring removal of items on the work surface.

FIGS. 1-5 show an exemplary tool chest having a sliding lid 24 providing a work surface 60. In some embodiments, the movable work surface 60 is defined as the upper surface of the sliding lid 24 of the sliding door assembly 52. The work surface 60 is movable, slidingly, as the sliding lid 24 is moved between an open and a closed position. Movement of the sliding lid to the open position provides access to the interior space of the compartment. The pivotable lid assembly 50 has a pivotable lid 22 movable between open and closed positions. The sliding lid 24 is mounted, movably, on the pivotable lid assembly 50 such that movement of the pivotable lid 22 pivotally moves the work surface 60 and the sliding lid 24. The pivotable lid 22 moves from a closed position wherein the work surface 60, defined on the sliding lid 24, is generally horizontal, to an open position wherein the pivotable lid 22, work surface 60 and sliding lid 24 are all moved pivotally, away from the horizontal and towards (and possible past) a generally vertical position. In its open position, the pivotable lid 22 allows access to the interior space 20 but does not maintain the work surface 60 in a usable, generally horizontal position. In such embodiments, the pivotable lid assembly provides for pivoting movement of the sliding lid. Also in such embodiments, sliding movement of the slidable lid does not result in movement of the pivotable lid. In such embodiments, the slidable lid assembly 52, and slidable lid 24, are mounted to or mounted above the pivotable lid assembly 50 or pivotable lid 22. Movement of the pivotable lid causes pivotal movement of the slidable lid, however, movement of the slidable lid does not cause sliding movement of the pivotable lid.

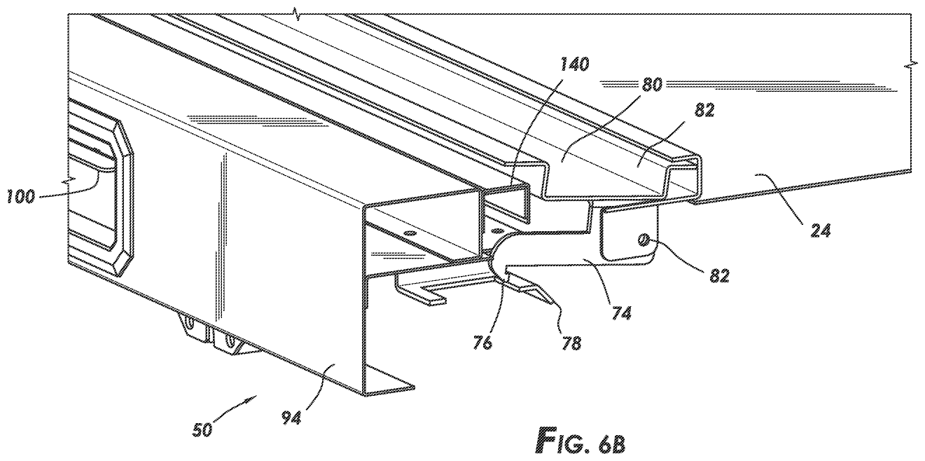

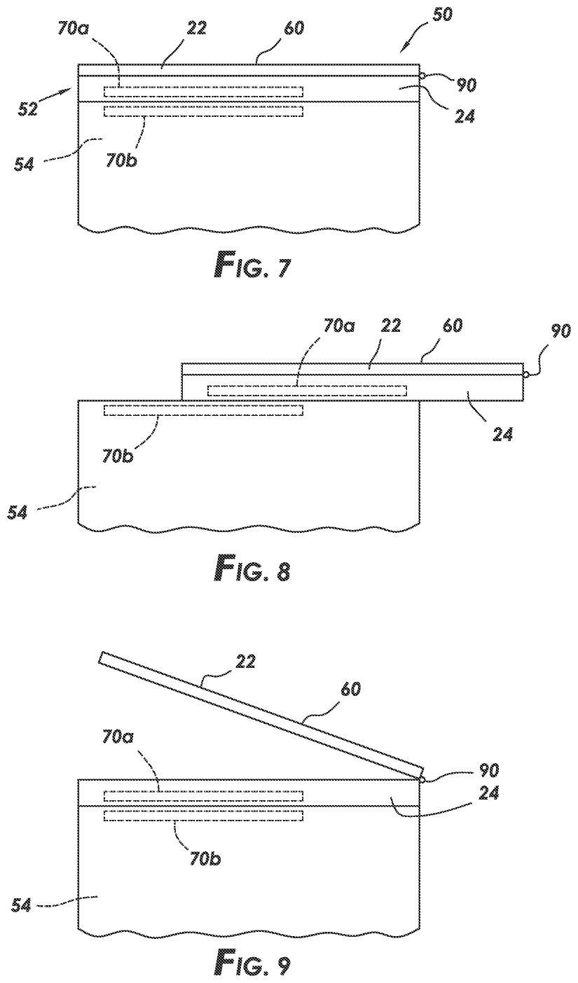

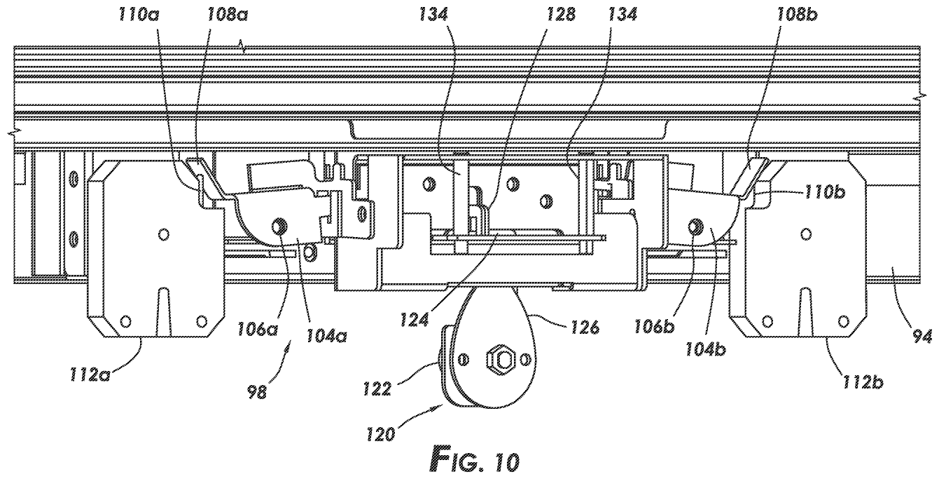

FIGS. 7-9 are side views of an exemplary embodiment of the disclosure having a lid assembly with a pivotable lid mounted to a slidable lid. FIG. 7 is a side view of an exemplary embodiment of the disclosure having a lid assembly with a pivotable lid mounted to the slidable lid assembly, with both pivotable and slidable lids in a closed position. FIG. 8 is a side view of the exemplary embodiment of the disclosure of FIG. 7, wherein the slidable lid is in an open position and the pivotable lid is in a closed position. FIG. 9 is a side view of the exemplary embodiment of the disclosure of FIG. 7, wherein the pivotable lid is in an open position and the slidable lid is in a closed position. These Figures are discussed together.

In such embodiments, the movable work surface 60 is defined as the upper surface of the pivotable lid 22 of the pivotable lid assembly 50. The work surface 60 is movable pivotally as the pivoting lid 22 is moved between an open and a closed position. Movement of the pivoting lid 22 to the open position provides access to the interior space 20 but does not maintain the work surface 60 in a usable position for supporting tools and the like. The slidable lid assembly 52 has a slidable lid 24 movable between open and closed positions such as on cooperating rail members 70a-b. The pivotable lid 22 is mounted (movably) on the sliding lid assembly 52 such that sliding movement of the sliding lid 22 also slidingly moves the work surface 60 and the pivotable lid 22. The sliding lid 24 moves from a closed position wherein the work surface 60, defined on the pivotable lid 22, is positioned above and aligned with the interior space 20, and an open position wherein the sliding lid 24, work surface 60 and pivotable lid 22 are all moved slidingly away from a position over the interior space 20 (e.g., towards the rear of the interior space and cantilevered over the rear of the chest). In this open position, the sliding lid 24 allows access to the interior space 20. In such embodiments, the sliding lid assembly 52 provides for sliding movement of the pivotable lid 22. Also in such embodiments, pivoting movement of the pivotable lid 22 does not result in movement of the sliding lid 24. In such embodiments, the pivotable lid assembly 50, and pivotable lid 22, are mounted to or above the slidable lid assembly 52 or slidable lid 24. Movement of the slidable lid causes sliding movement of the pivotable lid, however, movement of the pivotable lid does not cause pivoting movement of the slidable lid.

### Slidable Lid Assembly

The slidable lid assembly 52 has at least one slidable lid 24 and at least one rail assembly 62 for allowing selective sliding movement of the sliding lid 24. The sliding lid assembly 52 can also include a locking mechanism, latching mechanism, handle, wall flanges, and other features.

The slidable lid 24 is movable between an open position and a closed position and remains in a generally horizontal position in both positions and while being moved between positions, as long as the pivotable lid 22 remains closed. In an open position, the slidable lid 24 provides access to the interior space 20 while the pivotable lid 22 remains closed.

Turning to the slidable lid assembly 52 seen in FIGS. 4 and 5A-B, wherein the slidable lid 24 is mounted on the pivotable lid assembly 50, the sliding lid 24 defines a generally horizontal work surface 60 on which the user can place tools, work pieces, projects and the like. The work surface 60 of the sliding lid 24 remains available to the user for supporting objects when the sliding door is in the open position and the closed positions as long as the pivoting lid 22 remains closed.

The slidable lid assembly 52 includes a slidable lid 24 having walls or flanges, namely, side flanges 64, a rear flange 66, and a front flange 67, and a slidable lid latch assembly 72. The flanges 64, 66 and 67 create a raised peripheral wall around the slidable lid 24 for maintaining tools and the like on the lid. The side flanges 64 also act as mounting members for rail members 70a of the rail assemblies 70, which slidably connect to cooperating rail members 70b mounted, in this example, to side frame members 92 of the pivotable lid assembly 50.

The slidable lid assembly can incorporate multiple rail assemblies of various type, as are known in the art, which can support the slidable lid directly or indirectly (as through supporting a connected flange or the like), which support the lid along its sides (as seen), from below, or otherwise. The rail members 70b can be defined by one or more slidable lid assembly part, such as a flange, support member or the like, or, as shown, can be mounted to the slidable lid assembly flanges, lid or other parts. Similarly, the cooperating rail members 70a can be defined by the pivotable lid assembly or its parts, the compartment walls, or other parts of the tool, chest. The rail assemblies allow for selective movement of the slidable lid 24 between the open and closed positions. In some embodiments, such as seen at FIGS. 7-9, the rail assemblies 70 can be mounted to the slidable lid assembly, such as to the slidable lid, a slidable lid flange, etc., with the cooperating rail member attached to the walls of the compartment 54, support members for the compartment, etc.

Rail assemblies are known in the art, and, as used herein, include track assemblies, rail assemblies, cooperating rail and groove assemblies, slide bearing assemblies, and other types of sliding assemblies as are known in the art. Such assemblies can use wheels which run along one or more tracks, ball bearings supporting relatively movable rails, drawer slides, ball bearing slides, euro slides, and the like. Alternately, the rail assembly can operate using simple friction fit between rails and runners, rail and groove, track and runners, etc. For example, the rail assembly can be drawer slides.

The slidable lid assemblies seen in the Figures have a single sliding lid. In some embodiments, the slidable lid assembly can comprise multiple sliding lids, such as, for example, two adjacent sliding lids which slide away from one another (e.g., one to the left, one to the right). For example, a two slidable lid assembly can have two sliding lids, which slide from adjacent closed positions to a spaced apart open position.

Where the slidable lid 24 provides a work surface 60 (in both the open and closed positions), a stop, shoulder or other motion limiter can be used to limit the range of motion of the slidable lid. In some embodiments, the slidable lid, when in the fully open position, as seen in FIG. 4, does not slide the full width of the upper (or lower) assembly, or the entire width of the interior space 20. Such an arrangement may prevent the slidable lid (including any work pieces thereon) from cantilevering outwards too far, so as to become a hazard for overbalancing the tool chest. A stop or shoulder can be provided to limit horizontal movement of the slidable lid for this purpose.

### Slidable Lid Latch

The slidable lid assembly 52 can include a releasable latch assembly 72, as most clearly seen in FIGS. 6A-B. FIG. 6A is a detail, cross-sectional view of an exemplary latch assembly 72 with the latch assembly in a latched position. FIG. 6B is a detail, cross-sectional view of the latch assembly of FIG. 6A with the latch assembly in an unlatched position.

FIG. 6A shows a selectively releasable latch assembly 72 for the slidable lid 24 in a latched position. The latch assembly 72 includes a pivoting lever 74, which pivots about a hinge 84, having a hook 76 for cooperating with a corresponding stationary catch 78. The lever 74 is fixedly attached to a manually operated release bar 80. In the embodiment shown, the release bar 80 is generally U-shaped channel and is operated by manually pressing (e.g., with a thumb) on the rear wall 82 of the channel 80. A biasing mechanism, such as coil spring, leaf spring, torsion spring, weighted lever, or other mechanism as is known in the art, biases the slidable lid latch assembly towards a latched position, as seen in FIG. 6A. In this manner, the slidable lid is automatically latched when moved to the closed position. The catch 78 is mounted to a member of the tool chest which remains stationary when the slidable lid 24 is moved. In the exemplary embodiment seen in FIGS. 6A-B, the catch 76 is mounted to the pivotable lid assembly 50, and more specifically to the frame member 94. When in the latched position, FIG. 6A, the hook 76 cooperates with the catch 78 to prevent sliding movement of the slidable lid 24. Manually operating the release bar 80 by pressing on the rear wall 82, as seen in FIG. 6B, places the latch assembly in an unlatched position wherein the lever 74 is pivoted about the hinge 84, moving the hook 76 such that the catch 78 no longer prevents sliding movement of the slidable lid 24 and attached release bar 80, lever 74, etc.

Where the sliding lid 24 is mounted on the pivoting lid assembly 50 (such that pivoting the pivotable lid 22 also pivots the slidable lid 24), the releasable latch assembly 72 maintains the slidable lid in the closed position while the pivoting lid is raised and lowered. This is a safety mechanism to prevent the sliding lid from accidently opening, for example, under its own weight, when the pivoting lid is used.

The latching assembly shown is merely exemplary. Other latching mechanisms are known in the art, such as compression latches, gravity latch, fingertip release latch, bolt latch, spring-loaded latch, thumb latch, slide lock, finger lock, hasp, etc. Further, while the U-shaped channel release bar 80 extends across the length of the slidable lid 24, providing a convenient tray (for smaller items, like fasteners and the like), it is also possible to employ other release bars and mechanisms which use less space. For example, two small latch releases can be placed at either end of the front of the slidable lid 24, each operating a lever mechanism. Alternately, one or more smaller latches can be thumb or finger operated, operated using a press button, etc. Alternately, the slidable lid can be biased by a biasing mechanism towards the closed position, such that no latch is used.

A slidable lid locking assembly can also be provided, as are known in the art, to selectively lock the sliding lid in the closed position.

### Pivotable Lid Assembly

The pivotable lid assembly 50 is best seen in FIGS. 1-3, with details in FIGS. 5A-B. FIGS. 1 and 4 show the pivotable lid assembly 50 in a closed position. FIGS. 2-3 show the pivotable lid assembly 50 in an open position. (An alternate embodiment, seen in FIGS. 7-9, has already been discussed and is not addressed again in detail here.)

The pivotable lid assembly 50 generally consists of a pivotable lid 22 and a hinge assembly 90 for allowing pivoting movement of the pivoting lid about a hinge axis. The pivotable lid assembly 50 includes at least one pivoting lid 22. The pivotable lid assembly 50 can also include biasing mechanisms to support the pivotable lid in the open position, movement limiting mechanisms to control maximum movement of the pivotable door, one or more latching mechanisms, locking mechanism, handles, structural members, and the like.

The pivotable lid 22 is movable between open and closed positions. In the closed position, the pivotable lid is generally horizontal, as seen in FIGS. 1 (wherein the slidable lid is closed) and 4 (wherein the slidable lid is open). Moving from the closed to the open position, the front of the pivotable lid releases from the compartment 54 and pivots upwards, as seen in FIG. 2. In the open position, the pivotable lid moves towards or through a generally vertical position. In the open position the pivotable lid 22 can pivot to between approximately 45 and 120 degrees from the horizontal. The pivotable lid can move to an open position of 180 degrees or more from the closed position in some embodiments. In the open position, the pivotable lid allows access by the user to the interior storage space 20. For example, in an exemplary open position seen in FIG. 2, the pivoting door is approximately at 75-80 degrees above the horizontal. In some embodiments, the pivotable lid can rotate past the vertical. If the pivoting lid rotates past the vertical, a stop mechanism can be used to limit the travel of the pivoting lid and to maintain the pivoting lid in a selected open position.

The pivotable lid assembly 50 can include a frame comprising a plurality of frame members for supporting the pivotable lid 22 or for supporting the slidable lid assembly 52. The frame members in the exemplary embodiment under discussion comprise opposed and parallel side frame members 92 and/or opposed and parallel front and rear members 94. For example, the frame members can be joined together to form a generally rectangular frame. The frame members can provide support to the slidable lid when the sliding door is in the closed position. For example, at least one of the frame members can be attached to the slidable lid via a rail assembly as described elsewhere.

A hinge assembly 90 is provided for allowing selective movement of the pivotable lid 22 between open and closed positions. The exemplary hinge assembly 90 shown is mounted to the pivotable lid 22 and a rear wall of the compartment 54. (In the embodiment sees in FIGS. 7-9, the hinge assembly 90 attaches the pivotable lid 22 to the slidable lid assembly 52.) Persons of skill in the art will recognize other places suitable for attachment of the hinge assembly.

Hinge assemblies are known in the art. Hinge assemblies, as used herein, include leaved or plated hinge assemblies, such as butt hinges, ball bearing hinges, spring loaded or biased hinges, barrel hinges, concealed hinges, overlay hinges, piano hinges, scissor hinges, and the like as are known in the art. Hinges can also be of the type that are formed by cooperating parts defined on or mounted to the hinged members. For example, pins or bars can be defined on one of the hinged members (e.g., the pivoting lid and the slidable lid assembly) and cooperating grooves or notches formed or mounted on the other hinged member. A pivoting or hinged movement can be accomplished through a single axis, such as along the pin of a hinge (as shown), or through multiple axes, such as on a multiple-jointed hinge, or a linkage system.

FIGS. 2-3 show an exemplary biasing mechanism 96 for maintaining the pivotable lid 22 in the open position. The biasing assembly shown is a rod and cylinder strut assembly and can be gas charged. As shown, one end of the biasing assembly is mounted to the pivotable lid, such as at a side frame member 92, and the other end of the biasing assembly is mounted to a side wall of the compartment 54. Other biasing mechanisms are known in the art such as spring mechanisms, torsion or coil springs, spring loaded linkage systems, etc. The bias assembly can maintain the pivotable lid in the open position and/or can reduce the amount of force needed by the user to open the pivotable lid. One or more biasing mechanisms can be utilized. The biasing mechanisms can be provided with a user-operated, releasable lock to maintain the biasing mechanism in a fully extended position.

In some embodiments, the biasing mechanism is a lift assembly which automatically pivots the pivotable lid towards or to the open position as soon as the pivotable lid is unlatched. The force with which the lift assembly lifts is selected specifically for the weight of the members of the tool chest which pivot when the pivotable lid is opened (e.g., the pivotable lid, slidable lid, frame members, etc.). Further, the lift assembly can be selected so that it will not automatically open if items are positioned on the work surface. That is, the additional weight of the tools or items on the work surface make the to-be-pivoted members too heavy for the lift assembly to lift. This prevents accidental opening of the pivotable lid while tools are still positioned in the work surface.

### Pivotable Lid Latch Assembly

A releasable latch assembly 98 can be used in conjunction with the pivotable lid 22. An exemplary latch assembly is disclosed herein. Latch assemblies are known in the art and a person of skill in the art will recognize workable alternative latch assemblies.

FIG. 10 is a detail partial rear view of the latch assembly 98 which is mounted behind the front member 94 of the pivotable lid assembly 50. The latch handle 100 can be seen in FIGS. 1-2 and 5A-B, for example. A user unlatches the pivotable lid latch by using the handle 100, for example, by lifting the handle upwards. When the pivotable lid is closed, the pivotable lid latch preferably automatically moves to the latched position, preventing opening of the pivotable lid. A biasing mechanism can be applied to the handle 100, for example, to bias it towards the latched position.

The handle 100 defines or is connected to an interior handle plate 102, seen in FIG. 10, which moves up with the handle 100 as it is lifted by the user. Movement of the interior handle plate 102 causes rotation of the lever members 104a-b (104a counterclockwise; 104b clockwise) about pivots 106a-b, respectively. Rotation of the lever members 104 cause lever plates 108a-b to depress cooperating depressible pins 110a-b. The depressible pins 110a-b are mounted on latch mechanisms 112a-b, respectively, and cause the latch mechanisms 112 to move a latch member from a cooperating catch member (not shown) defined on or attached to the pivotable lid 22. In the latched position, movement of the pivotable lid is prevented; in the unlatched position the pivotable lid can be opened.

### Locking Assembly

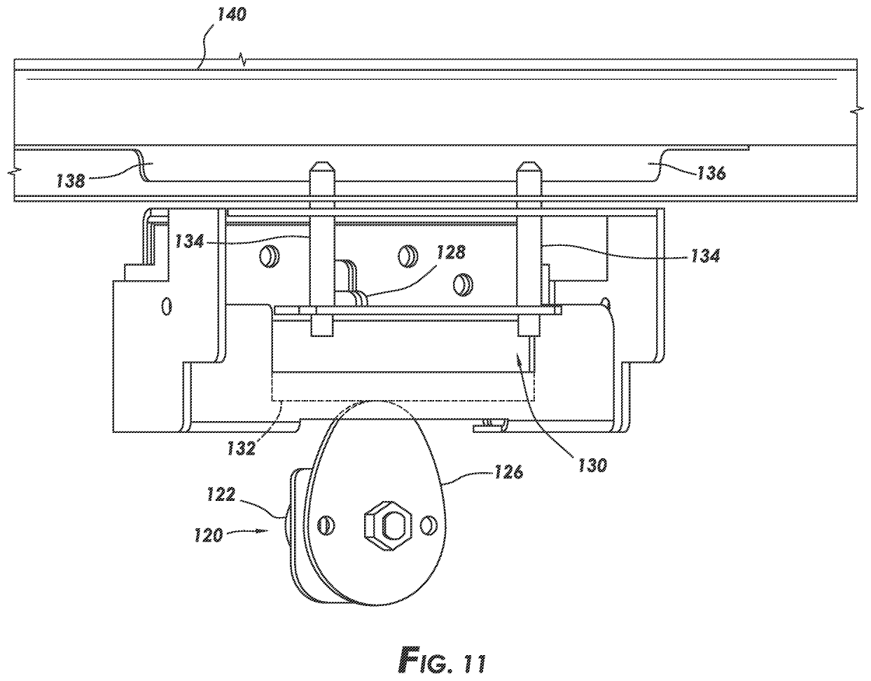

A locking assembly can also be provided, as is known in the art, to selectively lock the pivotable lid and/or slidable lid in closed positions. An exemplary locking mechanism can be seen in FIGS. 10-11. FIG. 11 is a detail partial rear view of an exemplary locking assembly 120 according to aspects of the disclosure, with the locking assembly in a locked position.

The locking assembly 120 includes a key-operated lock assembly 122. Use of lock assemblies is known in the art and not described in detail. Further, other locking assemblies, such as combination locks can be used, as those of skill in the art will understand. The key operates the front of the lock assembly 122. The rear of the lock assembly is seen in rear views FIGS. 10-11. Turning of the key operates to rotate both a hook 124 (as seen in FIG. 10) and a cam 126. The hook 124 is movable from a locked position, as seen, wherein the hook cooperates with a catch 128 (here, a loop) attached to the pivotable lid for preventing opening of the pivotable lid 22, to an unlocked position wherein the hook 124 disengages from the catch 128, allowing opening of the pivotable lid. Further, rotation of the key also rotates the cam 126. The cam 126 is seen in a locked position in FIG. 11. The cam 126 operates to lift a slidable lid locking mechanism 130 comprising a plate 132, for contacting and being moved by the rotating cam 126, and attached pins 134. As the cam 126 rotates, it moves the locking mechanism 130 (plate 132 and pins 134) upwards into a locked position wherein the pins 134 cooperate with a catch 136, here a wall 138 of the channel 140 of the slidable lid assembly 52.

In some embodiments, a single locking assembly locks the pivotable lid, slidable lid and the various drawers 40 of the lower assembly 12. Alternately, separate lock assemblies can be used.

### Cooperating Latches

In some exemplary embodiments, a safety latching mechanism cooperates between the slidable lid assembly and the pivotable lid assembly. For example, a movable latch can cooperate with a catch or similar mechanism. The movable latch member and cooperating catch are mounted, one to the slidable lid and one to the pivotable lid assembly. The safety latch assembly moves to the latched position when the pivotable lid is moved from the closed position, or when a pivotable lid latch is actuated preparatory to opening the pivotable lid. For example, movement by the user of the pivotable lid latch to open the pivotable lid also acts to move the safety latch to a latched position, preventing movement of the slidable lid. For example, when the user operates the pivotable lid latch, preparatory to opening the pivotable lid, the movement of the pivotable lid latch causes a pin mounted on the pivotable lid assembly to move into a cooperating hole defined in the slidable lid. When the pivotable lid is closed, the pivotable lid latch moves to a closed position, which also operates to release the safety latch (e.g., by withdrawing the pin from the hole in the slidable lid). In another example, a spring loaded safety button can be actuated by movement of the pivotable lid. Upon actuation of the spring loaded button, a pin, etc., of the safety latch is moved to latch the slidable lid in the closed position.

Similarly, in versions of the tool chest wherein the pivotable lid is carried by the slidable lid assembly, a safety latch mechanism can be used to ensure that the pivotable lid remains closed when the slidable lid is open (or when a slidable lid latch is actuated preparatory to opening the slidable lid). Such a safety system can be used to prevent the chest from overbalancing if the slidable and pivotable doors are both open. In another embodiment, a safety mechanism prevents the slidable lid from being operated (e.g., latches the sliding door closed) when the pivotable lid is open.

### CONCLUSION

While the above description relates to a tool chest or the like, the disclosed embodiments can be used for providing access to compartments and interior spaces in various other pieces of equipment, furniture, appliances, medical supply boxes, etc. The disclosed devices and methods allow both sliding lid and pivoting lid access to an interior space and can be used in any setting where such access is beneficial.

While the making and using of various embodiments of the present disclosure are discussed in detail, it is appreciated that the present disclosure provides many applicable concepts that may be embodied in a wide variety of specific contexts. The specific embodiments discussed herein are merely illustrative of specific ways to make and use the disclosure. Only the claims appended hereto delimit the scope of any claimed inventions.

It is claimed:

1. A tool chest for storing and accessing tools, the tool chest comprising:
a body defining an interior space for holding tools;
a pivotable lid assembly and a slidable lid assembly for allowing selective access to the interior space;
the pivotable lid assembly having a pivotable lid pivotally movable between a closed position in which the pivotable lid is positioned generally above the interior space, and an open position in which the pivotable lid is pivoted to allow access to the interior space;
the slidable lid assembly having a slidable lid slidably movable between a closed position, in which the slidable lid is positioned generally above the interior space and an open position in which the slidable lid is slidingly moved to allow access to the interior space;
wherein the interior space is accessible when either the pivotable lid or the slidable lid is in the open position, and wherein the interior space is not accessible when the pivotable lid and the slidable lid are both in their respective closed positions.

2. The tool chest of claim 1, wherein the slidable lid is mounted on the pivotable lid such that pivotal movement of the pivotable lid results in pivotal movement of the slidable lid.

3. The tool chest of claim 1, wherein the pivotable lid is mounted on the slidable lid such that slidable movement of the slidable lid causes slidable movement of the pivotable lid.

4. The tool chest of claim 1, wherein the slidable lid assembly further comprises a plurality of rail assemblies with cooperating rail members mounted on the slidable lid and the tool chest body.

5. The tool chest of claim 1, wherein the slidable lid assembly further comprises a plurality of rail assemblies with cooperating rail members mounted on the slidable lid and the pivotable lid assembly.

6. The tool chest of claim 2, wherein the slidable lid defines a generally horizontal work surface which remains generally horizontal when the slidable lid is in the open or closed positions, as long as the pivotable lid is in its closed position.

7. The tool chest of claim 3, wherein the pivotable lid defines a generally horizontal work surface which remains generally horizontal when the slidable lid is in the open or closed positions, and when the pivotable lid is in the closed position.

8. The tool chest of claim 1, further comprising a plurality of electrical ports for providing electrical power mounted on the body and within the interior space.

9. The tool chest of claim 1, further comprising a pivotable lid latch assembly having a latch movable between a latched position wherein the pivotable lid is prevented from moving from the closed position, and an unlatched position wherein the pivotable lid is free to move.

10. The tool chest of claim 1, further comprising a slidable lid latch assembly having a latch movable between a latched position wherein the slidable lid is prevented from moving from the closed position, and an unlatched position wherein the slidable lid is free to move.

11. The tool chest of claim 2, further comprising a pivotable lid latch assembly having a pivotable lid latch movable between a latched position wherein the pivotable lid is prevented from moving from the closed position, and an unlatched position wherein the pivotable lid is free to move.

12. The tool chest of claim 11, wherein the pivotable lid assembly further comprises at least one biasing mechanism, biasing the pivotable lid towards the open position.

13. The tool chest of claim 12, wherein the biasing mechanism for biasing the pivotable lid towards the open position is a lift assembly which automatically pivots the pivotable lid towards the open position when the pivotable lid latch is in the unlatched position.

14. The tool chest of claim 13, wherein the lift assembly applies a selected force sufficient to move the pivotable lid from the closed position, but insufficient to move the pivotable lid and any tool supported by the pivotable lid.

15. The tool chest of claim 2, further comprising rail assemblies each having cooperating rail members, the cooperating rail members mounted to the slidable lid and to the pivotable lid assembly, thereby allowing sliding movement of the slidable lid with respect to the pivotable lid assembly.

16. The tool chest of claim 1, further comprising a locking assembly, the locking assembly simultaneously locking the slidable lid in its closed position and the pivotable lid in its closed position.

17. A container for storing and accessing items, the container comprising:
a container body defining an interior space for storing items;
a lid assembly for selectively allowing access to the interior space, the lid assembly having a pivotable lid and a slidable lid;
the lid assembly providing access to the interior space while the slidable lid is in a closed position, when the pivotable lid is moved from a closed position to an open position; and
the lid assembly providing access to the interior space while the pivotable lid is in a closed position, when the slidable lid is moved from a closed position to an open position.

18. The container of claim 17, wherein the interior space is accessible when either the pivotable lid or the slidable lid is in the open position, and wherein the interior space is not accessible when the pivotable lid and the slidable lid are both in their respective closed positions.

19. The container of claim 18, wherein the slidable lid is mounted on the pivotable lid such that pivotal movement of the pivotable lid results in pivotal movement of the slidable lid.

20. The container of claim 19, wherein the pivotable lid is mounted on the slidable lid such that slidable movement of the slidable lid causes slidable movement of the pivotable lid.

21. The container of claim 20, further comprising at least one rail assembly having cooperating rail members mounted on the slidable lid and the container body.

22. The container of claim 19, further comprising at least one rail assembly having cooperating rail members mounted on the slidable lid and the pivotable lid.

23. The container of claim 19, wherein the slidable lid defines a generally horizontal work surface which remains generally horizontal when the slidable lid is in the open or closed positions, as long as the pivotable lid is in its closed position.

24. The container of claim 20, wherein the pivotable lid defines a generally horizontal work surface which remains generally horizontal when the slidable lid is in the open or closed positions, as long as the pivotable lid is in its closed position.

25. A method of storing and accessing tool in a tool chest, the method comprising:
storing tools in an interior space defined in the tool chest;
accessing the interior space by pivotably moving a pivotable lid from a closed position to an open position;
accessing the interior space by slidably moving a slidable lid from a closed positon to a closed position.

26. The method of claim 25, further comprising: closing the interior space by moving the pivotable lid to the closed position.

27. The method of claim 25, further comprising: closing the interior space by moving the slidable lid to the closed position.

28. The method of claim 25, further comprising: providing access to the interior space by pivotably moving the pivotable lid to the open position, while the slidable lid is in the closed position.

29. The method of claim 25, further comprising: providing access to the interior space by slidably moving the slidable lid to the open position, while the pivotable lid is in the closed position.

30. The method of claim 25, further comprising positioning tools on an upper surface of the pivotable lid or the slidable lid, while the pivotable and slidable lids are in their respective closed positions; then slidably moving the slidable lid to its open position while the tools are maintained on the upper surface.
